(19) United States
(12) Patent Application Publication
(10) Pub. No.: US 2011/0052353 A1
(43) Pub. Date: Mar. 3, 2011

(54) APPARATUS AND METHOD FOR COLLECTING AND TRANSPORTING OIL WELL DRILL CUTTINGS

(76) Inventors: Charles Franklin Spenser, Elk City, OK (US); Lorraine Annette Thompson, Elk City, OK (US); James Harvey Hamric, Ward, AR (US)

(21) Appl. No.: 12/549,119

(22) Filed: Aug. 27, 2009

(51) Int. Cl. B65G 65/40; B65G 65/34

(52) U.S. Cl. 414/325; 414/808

(57) ABSTRACT

Sludge having drill cuttings produced while drilling an oil well are moved from a shaker screen to a holding tank. The sides of the holding tank slope toward each other and form a half circle trough at the bottom of the tank. A discharge opening is aligned with the trough, and a conveyer is located in the trough for moving sludge in the holding tank toward the discharge opening. A second incline conveyer or high suction vacuum source is coupled to the discharge opening to move sludge from the discharge opening of the holding tank into a container or drying system. A drying system is coupled between the high suction vacuum source, a container and the discharge opening to separate fluids from the sludge. A drying system located near the discharge end of an inclined conveyor and between the end and a container separates fluids from the sludge.

### BACKGROUND OF THE INVENTION

1. Field of the Invention

The present invention relates generally to oil well drill cuttings and more particularly to an apparatus and method of collecting drill cuttings from a shaker screen for transport and disposal.

2. Description of the Related Art

When drilling for oil, a drill bit at the end of a drill stem is lowered down-hole and rotated to drill through sand, rock, shale, etc. to a desired depth. During the drilling process, drilling mud is pumped through the drill stem to the drill bit. The drilling mud is used to lubricate the drill bit and to carry material that is cut by the drill bit to the surface. The return flow of the drilling mud from the drill bit to the surface is through the space between the drill stem and the well casing. The drilling mud contains, in addition to small pieces of shale, rock, sand etc., known as cuttings, oil-based lubricants that were added to lubricate the drill.

Due to its expense, it is desirable to recover as much of the drilling mud as possible for future use. The recovered drilling mud is processed in a shaker which removes cuttings.

A shaker that separates cuttings and other solids from the drilling mud normally has a downward sloping vibrating screen over which the recovered drilling mud flows. As the screen vibrates, fluids in the drilling mud drop down through small openings in the screen and the solids remain on the top of the screen. As the screen vibrates the solids on the top of the screen the cuttings, move down to the end of the screen and fall into a ditch or trough for collection.

The cuttings collected in the ditch or trough are still highly contaminated with the drilling fluids and are in the form of a relatively heavy sludge.

The sludge is toxic and can contaminate both surface and underground waters if not disposed of in an environmentally-friendly manner.

The systems currently used for transporting the sludge are highly labor intensive and can have a negative impact on the environment.

A method for removing and transporting cuttings from the shaker ditch or trough is to use a trackhoe to scoop the heavy sludge out of the collection ditch or trough and place it into a sealed container for transportation to a waste site or a reclamation center.

During the process of removing sludge from the shaker ditch or trough to a container, the bucket of the trackhoe moves up and down and swings from one side to the other. It is during this moving of the sludge by the trackhoe that a small amount of sludge is dropped on the ground during each pass. This inadvertent dropping of contaminated sludge on the ground happens with the very best of trackhoe operators.

What is needed is an apparatus and method for transferring sludge from a shaker to a container in a more environmentally friendly way.

### SUMMARY OF THE INVENTION

In an embodiment there is disclosed an apparatus for moving heavy drill cuttings produced in the drilling of an oil well from a shaker screen comprising:

An open top elongated shaped holding tank having a first side, a second side, a front end and a back end for receiving sludge having drill cuttings from said shaker screen;

A trough or slanted bottom having a front end and a back end located in the bottom of the holding tank;

A discharge opening located at one end of the holding tank which is aligned with the trough;

A conveyor located in the trough or bottom of the holding tank for moving sludge toward the discharge opening;

A container located next to the holding tank to receive sludge from the discharge opening; and

A pipe coupled from the discharge opening of the holding tank to a container to carry sludge from the holding tank to a container.

In another embodiment there is disclosed a method for moving heavy drill cuttings produced in the drilling of an oil well from a shaker that screen comprises:

placing an open top elongated shaped holding tank having a first side, a second side, a front end and a back near the shaker screen to receive sludge having drill cuttings;

Providing a trough or slanted bottom having a front end and a back end in the bottom of the holding tank;

Locating a discharge opening at one end of the holding tank which is aligned with the trough;

Locating a conveyor in the trough or bottom of the holding tank for moving sludge toward the discharge opening;

Locating a container to receive sludge from the discharge opening; and

Coupling a pipe from the discharge opening of the holding tank to a container to carry sludge from the holding tank to a container.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a diagram showing a shaker system where the tank for receiving sludge having cuttings is in accordance with the principles of the invention;

FIG. 2 is a side view of the holding tank in accordance with the principles of the invention;

FIG. 3 is a top view of the holding tank of FIG. 2;

FIG. 4 is a sectional view along the line 4-4 of FIG. 3;

FIG. 5 is a detail view of an end of the holding tank;

FIG. 6 is a partial side view of a truck having a high vacuum source for transferring sludge from the holding tank to a container.

### DETAILED DESCRIPTION OF THE INVENTION

This invention relates generally to the removal of oil well cuttings obtained while drilling an oil well with a drill bit on the end of a drill string located downhole. During drilling, the drill cuttings are carried to the surface with drilling mud that flows from the drill bit, between the drill string and the downhole to the surface.

More particularly, this invention relates to an improved oil well cuttings disposal system that collects oil well cuttings in a tank that has a horizontally positioned conveyor where the sludge is transferred to a container without spilling or leaking any sludge during the transfer process.

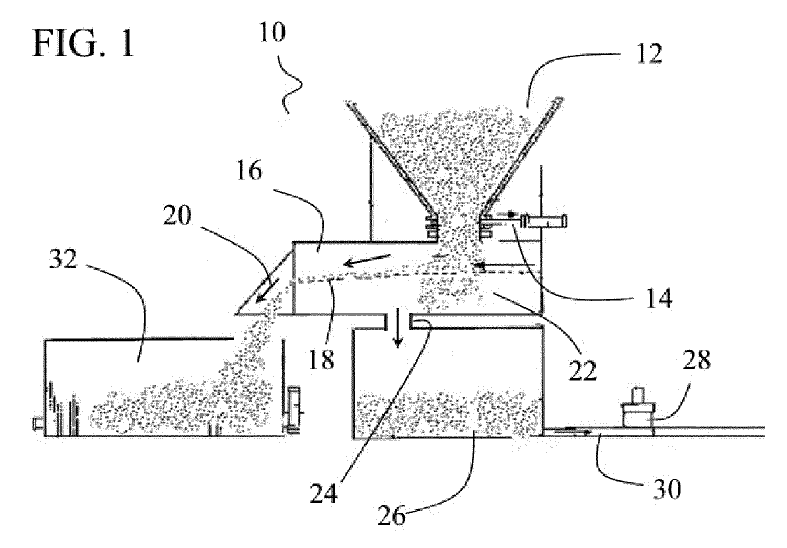

Referring to FIG. 1, there is shown a shaker system 10 that includes a tank for receiving cuttings in accordance with the principles of the invention. Drilling mud from a downhole is received in a hopper 12 that has an electrically operated valve 14 at its throat that is used to selectively allow drilling mud in the hopper to flow to shaker 18. In FIG. 1, valve 14 is open and drilling mud is flowing to shaker 16. Shaker 16 has a sloping vibrating screen 18 that separates the cuttings from the fluids in drilling mud from the hopper to sludge 20 and processed drilling mud 22. The processed drilling mud drops through the screen 18 and flows through drain opening 24 into the processed drilling mud storage tank 26. A pump 28 pumps the processed drilling mud from the storage tank through a discharge pipe 30 to an operating drilling operation for further use.

The sludge 20 that moves off the edge of the screen falls into the holding tank 32 where it is stored until it is discharged to a container for transportation to a land fill or a processing plant.

The holding tank 32 has two substantially flat panels that slope toward each other. At the bottom of the tank, the ends of the substantially flat sloping panels terminate with a trough. The trough is equipped with a conveyor that extends across the length of the tank. The conveyor is driven through means that provides a leak proof seal.

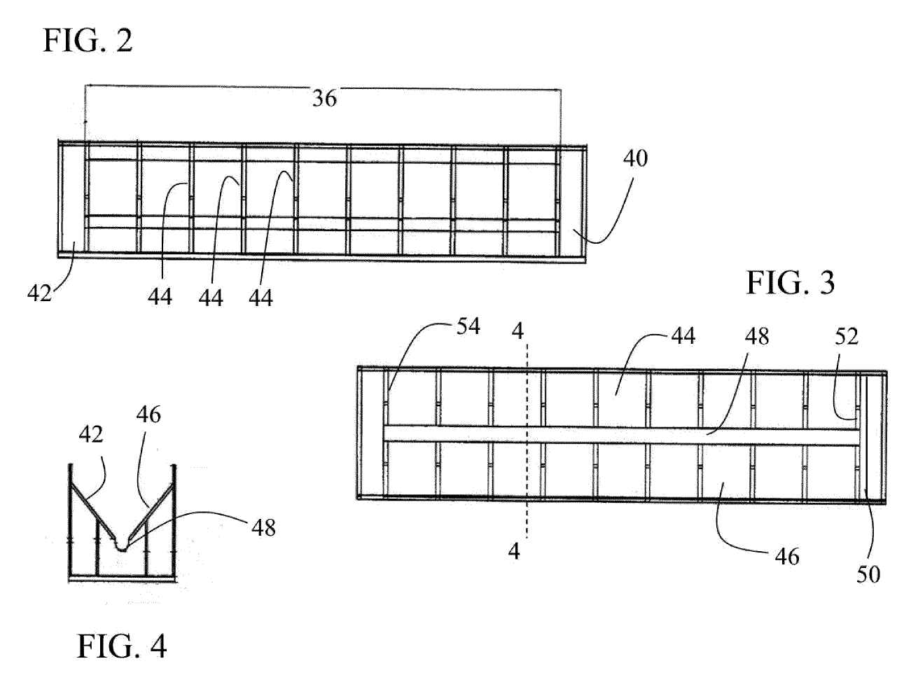

Referring to FIG. 2, there is shown a side view of holding tank 32. In an embodiment, the holding tank has four sides, slanted bottom and vertical ends to make a sealed container. One end of the holding tank has a motor that will drive the conveyor which is in the bottom of the box. The other end has a valve and mount. The mount is capable of attaching an inclined conveyor assembly or fittings for suction. The ends and the sides of the holding tank 32 are raised above the floor and are cradled by support members 44.

Referring to FIG. 3, there is shown a top view or the holding tank. The tank 32 consists of two side walls 44, 46 that slope toward each other and form a half circle trough 48 at the very bottom. The rear end wall 50 and front end wall 52 are substantially vertical.

Referring to FIG. 4, there is shown a sectional view along the line 4-4 of FIG. 3 of holding tank 32. Each side wall of the holding tank is composed of one or more flat sheets of steel.

The trough 48 (see FIG. 4) is located in the bottom of the holding tank.

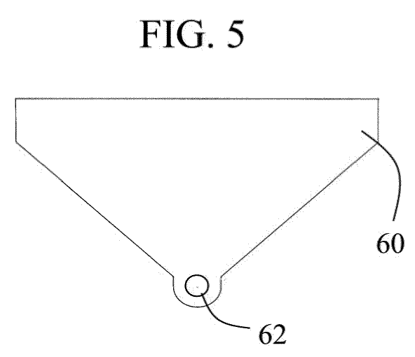

Referring to FIG. 5, there is shown a detail of the rear end 60 of the holding tank. Rear end 60 has an opening 62 for receiving a discharge pipe. The front end (not shown) of the holding tank is substantially similar to the rear end. The discharge pipe is adapted to be coupled to a removable leak proof cap and is adapted to be coupled to a rigid pipe or flexible hose for removing the sludge from the holding tank and carrying it to a rolloff box.

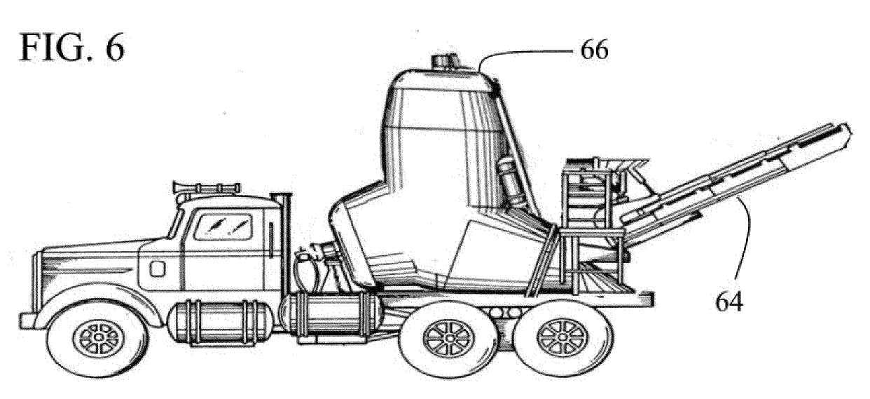

In one embodiment and looking at FIG. 6, sludge is removed from the holding tank with a super sucker such as a high suction vacuum source mounted on a truck or trailer. The high suction vacuum source has sufficient power to suck the sludge from the discharge pipe of the holding tank and deposits it in a container. In this embodiment, one end of a pipe, which may be a rigid pipe or a flexible hose, is coupled to the discharge pipe at the front end of the holding tank and the other end of the rigid pipe or flexible hose is coupled to the front or intake side of a container and the high suction vacuum source is attached to the rear or exhaust of the container. The couplings at each end of the rigid pipe or flexible hose are leak proof.

Looking at FIG. 6, there is shown a hose which is coupled in a leak proof manner to the suction port of a high suction vacuum source mounted on a truck. The other end of the hose is coupled to the exhaust side or rear side of a container. The intake side or front side of the container is coupled to the discharge pipe of the holding tank in a leak proof manner. The high suction vacuum source will apply suction through the container and hoses to the discharge pipe of the holding tank.

In operation, an operator brings the truck with the high suction vacuum source into position and connects the free end of hose 64 to the rear or exhaust side of a container. The operator then will connect hose or pipe from the intake or front side of a container to the discharge pipe at the front end of the holding tank. All connections are leak proof. The operator now turns on power to the high suction vacuum source and also turns on power to the electric motor that is connected to the conveyor located in the holding tank. The conveyor urges the sludge in the holding tank to move toward the discharge pipe and the high suction vacuum source on the truck sucks the sludge from the discharge pipe and discharges it into the container

When the container is full of sludge, the operator stops the conveyor from rotating by turning off the power to the electric motor. Then the operator disconnects the hose 64 from the discharge pipe of the holding tank, raises the hose 64 to allow any remaining sludge in the pipe to be sucked into the container via high suction vacuum, and then turns off power to the high suction vacuum source.

With the invention disclosed, none of the sludge is dropped on the ground while transferring sludge from the holding tank to a container.

In another embodiment, a second inclined conveyor is connected to the end of the discharge pipe at the front of the holding tank.

This second inclined conveyor pushes sludge from the discharge pipe at the front end of the holding tank up and into a container. In operation, an operator locates the outlet end of the second inclined conveyor to discharge the sludge directly into a container. To remove sludge from the holding tank, an operator turns on power to each of the conveyors. When the container is full, the operator turns off power to each of the conveyors and rotates the second inclined conveyor out of the way.

Again, as with the first noted embodiment, none of the sludge is dropped on the ground while transferring sludge from the holding tank to a container.

In another embodiment of the invention, the sludge is further dried before it is moved to a container. In this embodiment a drying system such as a drying system that is sized to process between 20 to 50 tons of sludge per hour is located on a truck or trailer. The drying system separates additional fluid such as oil, water etc. from the sludge. The separated fluid is stored in a container which can be given back to the mud system on the drilling rig, or stored for future use. The sludge, that is now a slightly damp substance, can be disposed of in any landfill, or used as a product.

In another embodiment the drying system can be located in the holding tank and the conveyor is coupled to move the sludge into the drying system for further drying. The dry sludge is moved from the drying system to a container with either a second conveyor or a high suction vacuum source, and the fluid from the drying system is pumped back to the mud system.

Transportation of the container can be done in two possible ways. One, the container is loaded onto a trailer and hauled. Two, the container has a rear axle and can be hauled with the use of a winch truck. The method of transportation with the use of a winch truck is new. No other container for cuttings is transported in this matter. The front of the container has a frame that allows a winch cable to be attached and the truck has a winch attached. The winch pulls on the cable and lifts the front of the container up and over the rear of the truck frame. The cable pulls the container up to and onto the truck hitch. The hitch locks the container to the truck and the truck tows the container as a trailer. The container has license, lights, brakes, making it legal to be operated on roadways.

Based upon the foregoing, it will be apparent that there has been provided a new and useful apparatus and method for reducing contaminates into the environment.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. Apparatus for moving heavy drill cuttings produced in the drilling of an oil well from a shaker screen comprising:
an open top elongated shaped holding tank having a first side, a second side, a front end and a back end for receiving a sludge having drill cuttings from said shaker screen;
a trough having a front end and a back end located in the bottom of the holding tank;
a discharge opening located in the front end of the holding tank which is aligned with the front end of the trough;
a conveyor located in the trough or bottom for moving sludge in the holding tank toward the discharge opening;
a container located to receive sludge from the discharge opening; and
a hose or pipe coupled to the discharge opening and the container to carry sludge from the discharge opening in the holding tank to the container.

2. The apparatus of claim 1 wherein said conveyors has a front end located near the discharge opening and a back end located near the back end of the holding tank.

3. The apparatus of claim 2 wherein the back end of the conveyor is coupled to an electric motor that is selectively energized to rotate said conveyor to urge sludge in the holding tank toward the discharge opening.

4. The apparatus of claim 3 wherein the first and second sides of the holding tank slope toward each other; and wherein the lower ends of the sides are shaped to form the trough.

5. The apparatus of claim 4 wherein the trough is a half circle.

6. The apparatus of claim 5 wherein a high suction vacuum source is coupled to the pipe to suck sludge out of the holding tank.

7. The apparatus of claim 6 wherein the high vacuum suction source sucks the received sludge through a hose or pipe and into a container.

8. The apparatus of claim 5 wherein the pipe coupled to the discharge opening is a second inclined conveyor for moving sludge from the discharge opening to the container.

9. The apparatus of claim 7 wherein a drying system is coupled between the discharge opening and the high vacuum suction source and container to separate fluid from cuttings in the sludge.

10. The apparatus of claim 7 wherein a drying system is located near the holding tank between the discharge end of the inclined conveyor and the container.

11. A method for moving heavy drill cuttings produced in the drilling of an oil well from a shaker screen comprising:
placing an open top elongated shaped holding tank having a first side, a second side, a front end and a back end near the shaker screen to receive sludge having drill cuttings;
providing a trough having a front end and a back end in the bottom of the holding tank;
locating a discharge opening in the front end of the holding tank which is aligned with the front end of the trough;
locating a conveyor in the trough for moving sludge in the holding tank toward the discharge opening;
locating a container to receive sludge from the discharge opening; and
coupling a hose or pipe to the discharge opening and a container to carry sludge from the discharge opening in the holding tank to a container.

12. The method of claim 11 wherein said conveyor has a front end located near the discharge opening and a back end located near the back end of the holding tank.

13. The method of claim 12 wherein the back end of the conveyor is coupled to an electric motor that is selectively energized to rotate said conveyor to urge sludge in the holding tank toward the discharge opening.

14. The method of claim 13 wherein the first and second sides of the holding tank slope toward each other; and wherein the lower ends of the sides are shaped to form the trough.

15. The method of claim 14 wherein the trough is a half circle.

16. The method of claim 15 wherein a high suction vacuum source is coupled to a hose or pipe to suck sludge out of the holding tank.

17. The method of claim 16 wherein the high vacuum suction source sucks the received sludge through a pipe and into the container from the discharge opening of the holding box.

18. The method of claim 15 wherein the pipe coupled to the discharge opening is a second inclined conveyor for moving sludge from the discharge opening to the container.

19. The method of claim 17 wherein a drying system is coupled between the discharge opening of the holding tank and the high vacuum suction source and a container to separate fluid from cuttings in the sludge.

20. The method of claim 17 wherein a centrifuge is located near the holding tank between the discharge end of an inclined conveyor and the container.
